(19) United States
(12) Patent Application Publication
(10) Pub. No.: US 2024/0020405 A1
(43) Pub. Date: Jan. 18, 2024

(54) EXTRACTED FIELD GENERATION TO FILTER LOG MESSAGES

(71) Applicant: VMWARE, INC., Palo Alto, CA (US)

(72) Inventors: CHANDRASHEKHAR JHA, Bangalore (IN); SIDDARTHA LAXMAN KARIBHIMANVAR, Bangalore (IN); YASH BHATNAGAR, Bangalore (IN)

(21) Appl. No.: 17/981,386

(22) Filed: Nov. 5, 2022

(30) Foreign Application Priority Data
Jul. 18, 2022 (IN) 202241040960

(51) Int. Cl. G06F 21/62

(52) U.S. Cl. CPC G06F 21/6218

(57) ABSTRACT

An example method may include displaying the plurality of log messages, including a first log message. Further, the method may include receiving an indication to extract a field based on a specified portion of log text of the first log message. Furthermore, the method may include inferring a first regular expression for the specified portion of the first log message using a Grok pattern. Further, the method may include inferring a second regular expression for a context of the extracted field using the Grok pattern. The context may be determined based on the specified portion. Further, the method may include generating a definition of the extracted field having the first regular expression and the second regular expression. Furthermore, the method may include filtering the plurality of log messages based on the definition of the extracted field.

### RELATED APPLICATIONS

Benefit is claimed under 35 U.S.C. 119(a)-(d) to Foreign Application Serial No. 202241040960 filed in India entitled “EXTRACTED FIELD GENERATION TO FILTER LOG MESSAGES”, on Jul. 18, 2022, by VMware, Inc., which is herein incorporated in its entirety by reference for all purposes.

### TECHNICAL FIELD

The present disclosure relates to computing environments, and more particularly to methods, techniques, and systems for generating extracted fields to filter log messages in the computing environments.

### BACKGROUND

Data centers execute numerous applications (e.g., thousands of applications) that enable businesses, governments, and other organizations to offer services over the Internet. Such organizations cannot afford problems that result in downtime or slow performance of the applications. For example, performance issues can frustrate users, damage a brand name, result in lost revenue, deny people access to services, and the like. In order to aid system administrators and/or application owners with detection of problems, various management tools have been developed to collect performance information about applications, operating systems, services, and/or hardware. A log management tool, for example, records log messages generated by various operating systems and applications executing in a data center. Each log message is an unstructured or semi-structured time-stamped message that records information about the state of an operating system, state of an application, state of a service, or state of computer hardware at a point in time.

Most log messages record benign events, such as input/output operations, client requests, logouts, and statistical information about the execution of applications, operating systems, computer systems, and other devices of a data center. For example, a web server executing on a computer system generates a stream of log messages, each of which describes a date and time of a client request, web address requested by the client, and Internet protocol (IP) address of the client. Other log messages, on the other hand, record diagnostic information, such as alarms, warnings, errors, or emergencies. System administrators and application owners use log messages to perform root cause analysis of problems, perform troubleshooting, and monitor execution of applications, operating systems, computer systems, and other devices of the data center.

However, over an entire data center, significantly huge amounts of unstructured log messages can be generated continuously by every component of the data center's infrastructure. As such, finding information within the log messages that identifies problems of virtualized computing infrastructure is difficult, due to the overwhelming scale and volume of the log messages to be analyzed.

### BRIEF DESCRIPTION OF THE DRAWINGS

FIG. 1A is a block diagram of an example computing environment, illustrating a field extraction unit to generate a definition of an extracted field for filtering log messages;

FIG. 1B is a block diagram of an example virtualized computing environment, illustrating a field extraction unit to generate a definition of an extracted field for filtering log messages;

FIG. 2 is a flow diagram illustrating an example computer-implemented method for dynamically generating a definition of an extracted field based on a specified portion of a first log message;

FIG. 3 is a flow diagram illustrating another example computer-implemented method for generating extracted fields to filter log messages in a computing environment;

FIG. 4A shows an example graphical user interface depicting a list of log messages;

FIG. 4B shows the example graphical user interface of FIG. 4A, depicting an option to provide a name of an extracted field;

FIG. 4C shows the example graphical user interface of FIG. 4A, depicting an example extracted field generated based on a specified portion of a log message;

FIG. 4D shows the example graphical user interface of FIG. 4A, depicting a list of filtered log messages extracted based on the extracted field; and

FIG. 5 is a block diagram of an example computing device including non-transitory computer-readable storage medium storing instructions to generate a definition of an extracted field.

The drawings described herein are for illustrative purposes and are not intended to limit the scope of the present subject matter in any way.

### DETAILED DESCRIPTION

Examples described herein may provide an enhanced computer-based and/or network-based method, technique, and system to dynamically generate an extracted field to filter log messages in a computing environment. The paragraphs [0016] to [0021] present an overview of the computing environment, existing methods to generate the extracted field, and drawbacks associated with the existing methods.

Computing environment may be a physical computing environment (e.g., an on-premise enterprise computing environment or a physical data center) and/or virtual computing environment (e.g., a cloud computing environment, a virtualized environment, and the like). The virtual computing environment may be a pool or collection of cloud infrastructure resources designed for enterprise needs. The resources may be a processor (e.g., central processing unit (CPU)), memory (e.g., random-access memory (RAM)), storage (e.g., disk space), and networking (e.g., bandwidth). Further, the virtual computing environment may be a virtual representation of the physical data center, complete with servers, storage clusters, and networking components, all of which may reside in a virtual space being hosted by one or more physical data centers. Example virtual computing environment may include different compute nodes (e.g., physical computers, virtual machines, and/or containers). Further, the computing environment may include multiple application hosts (i.e., physical computers) executing different workloads such as virtual machines, containers, and the like running therein. Each compute node may execute different types of applications and/or operating systems.

Many programs (e.g., applications, operating systems, services, and the like) and hardware components generate log messages to facilitate technical support and troubleshooting. In recent years, log management tools have been developed to extract metrics embedded in log messages. The metrics extracted from log messages may provide useful information that increases insights into troubleshooting and root cause analysis of problems. However, over an entire data center, significantly huge amounts of unstructured log data can be generated continuously by every component of the data center infrastructure. As such, finding information within the log data that identifies problems of computing infrastructure (e.g., virtualized computing infrastructure) may be difficult, due to the overwhelming scale and volume of log data to be analyzed.

To provide more insights about log content, some log management tools such as vRealize log insight cloud, VMware's cloud monitoring platform, may provide a feature called extracted fields where customers can configure a number of regular expressions on a given log message and will be able to extract the log data. The extracted fields may help the customers to query the log messages based on the data inside the log messages which makes the application debugging faster.

However, because log messages are unstructured, system administrators and/or application owners may have to manually generate the extracted field by constructing distinct regular expressions for each type of log message. The manual methods to generate the extracted field can be complex since the system administrators and/or application owners may have to input afield name, afield type, and three regular expressions corresponding to pre-context, post-context, and value in order to create the extracted fields. The field type may refer to a type of the field which user has to select from an available list. The value regular expression may represent the extracted field value. The pre-context regular expression may represent certain text before the value. The post-context regular expression may represent certain text after the value.

In such examples, the system administrators and/or application owners may have to manually construct the three regular expressions for the extracted field. Construction of regular expressions may involve a steep learning curve which is error prone, requires extensive debugging, and is time consuming. An imperfect regular expression may cause inaccuracies in the extracted fields and also miss extraction of a desired metric, resulting in incomplete or inaccurate information needed for troubleshooting and root cause analysis. The inaccurate information may also mislead the users which reduces the reliability of the software product.

Further, any generic regular expressions that may be generated either manually or automatically may match incorrect logs which the provide incorrect extracted field values. Furthermore, the more generic is the regular expression the more processor cycles may be consumed to process the text. Also, the manual methods may not be scalable, i.e., the system administrators and/or application owners may not create such extracted fields in bulk or auto suggestions based on logs because of the complex process.

Examples disclosed herein may provide a log management tool to extract structured data from a log message in the form of an extracted field with one click from users without the need for the users to configure all the parameters (e.g., the value, the pre-context, and the post-context). In an example, log management tool may display a plurality of log messages, including a first log message comprised of log text. For example, log messages, sometimes referred to as runtime logs, error logs, debugging logs, event data, are displayed in a graphical user interface. The log management tool may receive an indication to extract a field based on a specified portion of log text of the first log message. Further, the log management tool may generate a definition of the extracted field having a first regular expression that matches the specified portion and a second regular expression for a context of the extracted field that is determined based on the specified portion. The first regular expression and the second regular expression can be determined using a Grok pattern. In this example, the log management tool may generate the definition of the extracted field by populating a template of the extracted field with the first regular expression and the first regular expression. Further, the log management tool may filter the plurality of log messages based on the populated extracted field.

In the following description, for purposes of explanation, numerous specific details are set forth in order to provide a thorough understanding of the present techniques. However, the example apparatuses, devices, and systems, may be practiced without these specific details. Reference in the specification to “an example” or similar language means that a particular feature, structure, or characteristic described may be included in at least that one example but may not be in other examples.

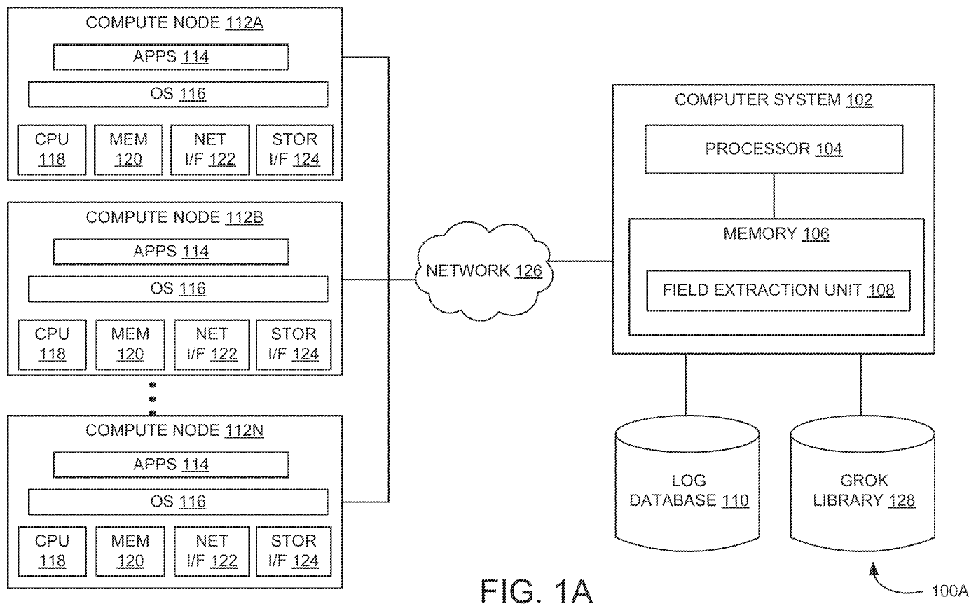

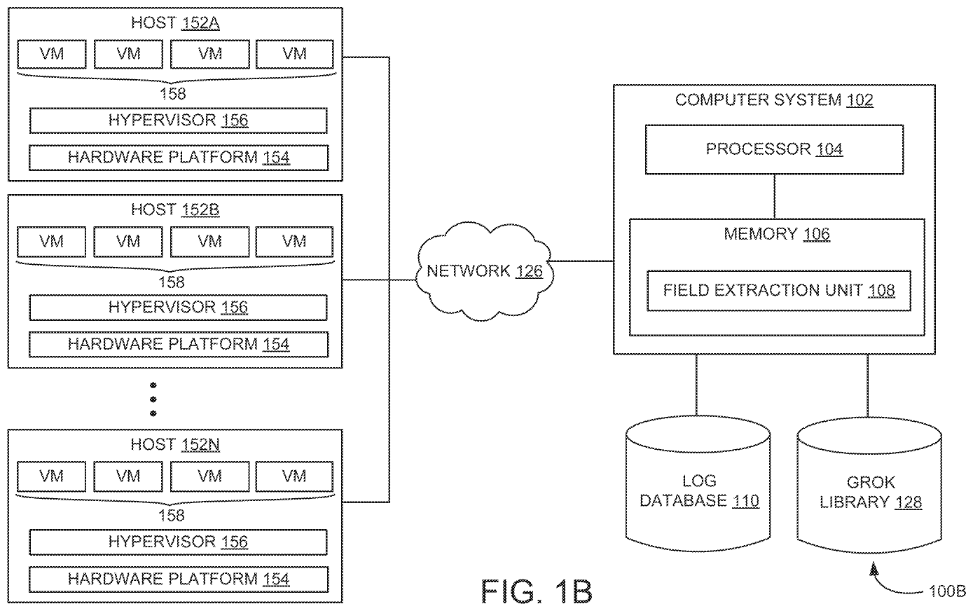

FIG. 1A is a block diagram of an example computing environment 100A, illustrating a field extraction unit 108 to generate a definition of an extracted field for filtering log messages. As illustrated, computing environment 100A includes a plurality of compute nodes 112A-112N (e.g., server systems), and referred to collectively as compute nodes 102. Each compute node 112 includes a central processing unit (CPU) 118, memory 120, networking interface 122, storage interface 124, and other conventional components of a computing device. Each compute node 112 further includes an operating system 116 configured to manage execution of one or more applications 114 using the computing resources (e.g., CPU 118, memory 120, networking interface 122, and storage interface 124).

Software and infrastructure components of computing environment 100A including compute nodes 112, operating systems 120, and applications 114 running on top of operating system 120, may generate log data during operation. Log data may indicate the state, and state transitions, that occur during operation, and may record occurrences of failures, as well as unexpected and undesirable events. In an example, log data may be unstructured text comprised of a plurality of log messages, including status updates, error messages, stack traces, and debugging messages. With thousands to millions of different processes running in a complex computing environment, an overwhelming large volume of heterogeneous log data, having varying syntax, structure, and even language, may be generated. While some information from log data may be parsed out according to pre-determined fields, such as time stamps, other information in the log messages may be relevant to the context of a particular issue, such as when troubleshooting or proactively identifying issues occurring in the computing environment 100A.

Further as shown in FIG. 1A, computing environment 100A may include a computer system 102 that is in communication with compute nodes 112 over a network 126. For example, network 126 can be a managed Internet protocol (IP) network administered by a service provider. Network 126 may be implemented using wireless protocols and technologies, such as Wi-Fi, WiMAX, and the like. In other examples, network 126 can also be a packet-switched network such as a local area network, wide area network, metropolitan area network, Internet network, or other similar type of network environment. In yet other examples, network 126 may be a fixed wireless network, a wireless local area network (LAN), a wireless wide area network (WAN), a personal area network (PAN), a virtual private network (VPN), intranet or other suitable network system and includes equipment for receiving and transmitting signals. Network 126 can also have a hard-wired connection to compute nodes 112.

In an example, computer system 102 provides some service to compute nodes 112 or applications 114 executing on compute nodes 112 via network 126. Further, computer system 102 includes a processor 104. The term “processor” may refer to, for example, a central processing unit (CPU), a semiconductor-based microprocessor, a digital signal processor (DSP) such as a digital image processing unit, or other hardware devices or processing elements suitable to retrieve and execute instructions stored in a storage medium, or suitable combinations thereof. Processor 104 may, for example, include single or multiple cores on a chip, multiple cores across multiple chips, multiple cores across multiple devices, or suitable combinations thereof. Processor 104 may be functional to fetch, decode, and execute instructions as described herein.

Further, computer system 102 includes a memory 106 coupled to processor 104. Memory 106 may be a device allowing information, such as executable instructions, cryptographic keys, configurations, and other data, to be stored and retrieved. Memory 106 is where programs and data are kept when processor 104 is actively using them. Memory 106 may include, for example, one or more random access memory (RAM) modules. In an example, memory 106 includes field extraction unit 108.

In an example, field extraction unit 108 may be a log analytics tool to collect, store, and analyze the log data. Example field extraction unit 108 may be enabled by vRealize Log Insight Cloud, which is VMware's cloud monitoring platform. A log database 110 may collect log data from compute nodes 112 that the log analytics tool (e.g., vRealize Log Insight) can ingest and analyze. In an example, log database 110 may be provided in a storage device that is accessible to computer system 102.

During operation, field extraction unit 108 may be configured to perform lexical analysis on the log data to convert the sequence of characters of log text for each log message in the log data into a sequence of tokens (i.e., categorized strings of characters). Further, field extraction unit 108 may use lexical analysis to generate definitions for fields dynamically extracted from the log text using a Grok pattern.

In an example, field extraction unit 108 may display the plurality of log messages, including the first log message comprised of log text, on a graphical user interface. In an example, a log message may be a file including information about events that have occurred within an application or an operating system of a compute node (e.g., compute node 112A). These events are logged out by the application or the operating system and written to the file. Further, as described above, such files may be collected and stored in log database 110.

Further, field extraction unit 108 may receive an indication to extract a field based on a specified portion of log text of the first log message. For example, field extraction unit 108 may receive a text selection, from a user via the graphical user interface, which indicates the specified portion of log text. Furthermore, field extraction unit 108 may generate a definition of the extracted field having a first regular expression that matches the specified portion and a second regular expression for a context of the extracted field. The context is determined based on the specified portion.

In this example, the first regular expression and the second regular expression may be determined using the Grok pattern. For example, the first regular expression may include a value type determined for the specified portion based on a match from the Grok pattern. The second regular expression for the context may include a before pattern that matches at least two tokens of log text before the specified portion and an after pattern that matches at least two tokens of log text after the specified portion. The context associated with the extracted field may be comprised of string values, patterns, or regular expressions that match log text before and after the specified portion.

The Grok patterns may be predefined symbolic representations of regular expressions that reduce the complexity of manually constructing regular expressions. The Grok patterns may be categorized as either primary Grok patterns or composite Grok patterns that are formed from primary Grok patterns. A Grok pattern is called and executed using the notation Grok syntax % {Grok pattern}. For example, a user may define a Grok pattern MYCUSTOMPATTERN as the combination of Grok patterns %{TIMESTAMP_ISO8601} and %{HOSTNAME}, where TIMESTAMP ISO8601 is a composite Grok pattern and HOSTNAME is a primary Grok patter. Grok patterns may be used to map specific character strings into dedicated variable identifiers.

For example, a Grok syntax for using a Grok pattern to map a character string to a variable identifier is given by:
%{GROK_PATTERN:variable_name}
where GROK_PATTERN represents a primary or composite Grok pattern, and variable_name is a variable identifier assigned to a character string in text data that matches the GROK_PATTERN.

A Grok expression is a parsing expression that is constructed from Grok patterns that match characters strings in text data and may be used to parse character strings of a log message. Consider, for example, the following simple example segment of a log message:
34.5.243.1 GET index.html 14763 0.064

A Grok expression that may be used to parse the example segment is given by:
“^%{IP:ip_address}\s%{WORD:word}s%{URIPATHPARAM:request}\s %{INT:bytes}\s %{NUMBER:duration}$”

The hat symbol “^” identifies the beginning of the Grok expression. The dollar sign symbol “$” identifies the end of the Grok expression. The symbol “\s” matches spaces between character strings in the example segment. The Grok expression parses the example segment by assigning the character strings of the log message to the variable identifiers of the Grok expression as follows:
ip_address: 34.5.243.1
word: GET
request: index.html
bytes: 14763
duration: 0.064

The Grok pattern may be defined expressions which may be similar to regular expression for a given string. Further, the Grok pattern may transform an unstructured data to a structured data by extracting metadata from the unstructured data. The Grok expression represents definition of a string or log in out context. There can be N number of log messages which can fall under a fixed grok expression. Further, the Grok expression may match the patterns, extract the fields from the logs and assign them to specified variables defined in the expression.

In an example, field extraction unit 108 may construct a first Grok expression and a second Grok expression from character strings of the specified portion and the context, respectively. Further, field extraction unit 108 may generate the first regular expression for the specified portion from the first Grok expression using a Grok library 128. Furthermore, field extraction unit 108 may generate the second regular expression for the context from the second Grok expression using Grok library 128. Further, field extraction unit 108 may generate the definition of the extracted using the first regular expression and the second regular expression.

In an example, Grok library 128 may include a set of pre-built common patterns, organized as files. The pre-built common patterns are library of expressions that helps to extract data from the log messages. The built-in patterns may be used for filtering items such as words, numbers, dates, and the like. Grok library 128 may also support to define custom patterns. Grok library 128 may enable to quickly parse and match potentially unstructured data (i.e., the first log message) into a structed result (i.e., the extracted field).

Further, field extraction unit 108 may concatenate first regular expressions corresponding to the at least two tokens before the specified portion using a delimiter (e.g., space) and populate the concatenated first regular expressions as a pre-context for the extracted field. Furthermore, field extraction unit 108 may concatenate second regular expressions corresponding to the at least two tokens after the specified portion using a delimiter and populate the concatenated second regular expressions as a post-context for the extracted field. Furthermore, field extraction unit 108 may filter the plurality of log messages based on the definition of the extracted field. While examples in FIG. 1A are described in conjunction with a computing environment having physical components, it should be noted that the log data may be generated by components of other alternative computing architectures, including a virtualized computing system as shown in FIG. 1B.

FIG. 1B is a block diagram of an example virtualized computing environment 100B, illustrating a field extraction unit 108 to generate a definition of an extracted field for filtering log messages. Similarly named elements of FIG. 1B may be similar in structure and/or function to elements described in FIG. 1A. As illustrated, virtualized computing environment 100B includes a group of host computers, identified as hosts 152A-152N, and referred to collectively as hosts 152. Each host 152 is configured to provide a virtualization layer that abstracts computing resources of a hardware platform 154 into multiple virtual machines (VMs) 158 that run concurrently on the same host 152. Hardware platform 154 of each host 152 may include conventional components of a computing device, such as a memory, processor, local storage, disk interface, and network interface. VMs 158 may run on top of a software interface layer, referred to herein as a hypervisor 156, that enables sharing of the hardware resources of host 152 by the virtual machines. One example of hypervisor 156 that may be used in an embodiment described herein is a VMware ESXi hypervisor provided as part of the VMware vSphere solution made commercially available from VMware, Inc. Hypervisor 156 may run on top of the operating system of host 152 or directly on hardware components of host 152. Each VM 158 may include a guest operating system (e.g., Microsoft Windows, Linux, and the like) and one or more guest applications and processes running on top of the guest operating system.

Software and infrastructure components of virtualized computing environment 100B including VMs 158, the guest operating systems, and the guest applications running on top of guest operating systems, may generate log data during operation. During operation, field extraction unit 108 may utilize a Grok pattern to generate a definition of the extracted field having a first regular expression that matches a specified portion of a first log message and a second regular expression for a context of the extracted field that is determined based on the specified portion as described with respect to FIG. 1A.

In some examples, the functionalities described in FIGS. 1A and 1B, in relation to instructions to implement functions of field extraction unit 108 and any additional instructions described herein in relation to the storage medium, may be implemented as engines or modules including any combination of hardware and programming to implement the functionalities of the modules or engines described herein. The functions of field extraction unit 108 may also be implemented by a processor. In examples described herein, the processor may include, for example, one processor or multiple processors included in a single device or distributed across multiple devices.

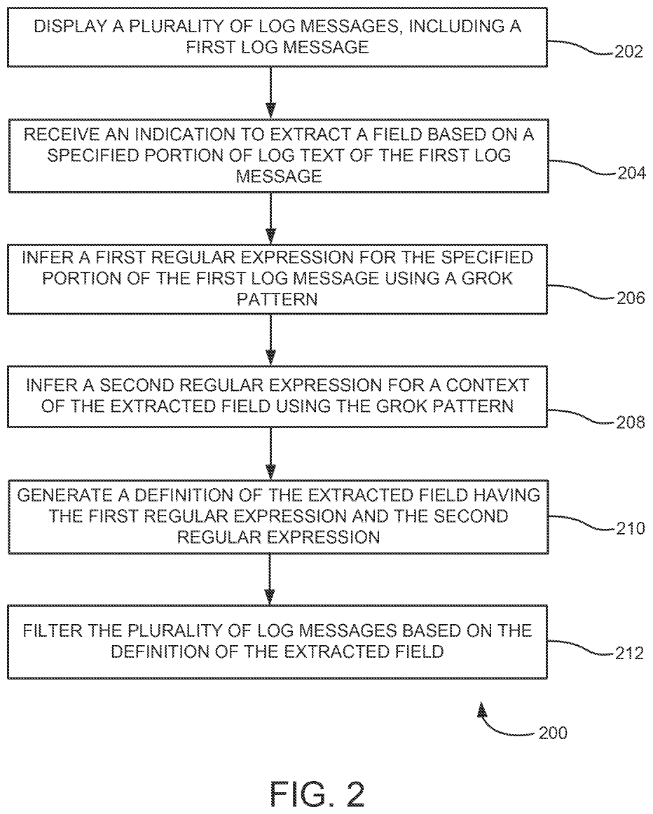

FIG. 2 is a flow diagram illustrating an example computer-implemented method 200 for dynamically generating a definition of an extracted field based on a specified portion of a first log message. Example method 200 depicted in FIG. 2 represents generalized illustrations, and other processes may be added, or existing processes may be removed, modified, or rearranged without departing from the scope and spirit of the present application. In addition, method 200 may represent instructions stored on a computer-readable storage medium that, when executed, may cause a processor to respond, to perform actions, to change states, and/or to make decisions. Alternatively, method 200 may represent functions and/or actions performed by functionally equivalent circuits like analog circuits, digital signal processing circuits, application specific integrated circuits (ASICs), or other hardware components associated with the system. Furthermore, the flow chart is not intended to limit the implementation of the present application, but the flow chart illustrates functional information to design/fabricate circuits, generate computer-readable instructions, or use a combination of hardware and computer-readable instructions to perform the illustrated processes.

At 202, the plurality of log messages including a first log message may be displayed. At 204, an indication to extract a field based on a specified portion of log text of the first log message may be received. In an example, receiving the indication to extract the field based on the specified portion may include receiving a text selection, from a user via the graphical user interface, which indicates the specified portion of log text.

At 206, a first regular expression may be inferred for the specified portion of the first log message using a Grok pattern. For example, the first regular expression associated with the definition of the extracted field may be a value type determined for the specified portion based on a match from the Grok pattern. In an example, inferring the first regular expression for the specified portion may include constructing a first Grok expression from character strings of the specified portion and generating the first regular expression may be generated for the specified portion from the first Grok expression using a Grok library.

At 208, a second regular expression may be inferred for a context of the extracted field using the Grok pattern, where the context is determined based on the specified portion. For example, the second regular expression for the context may include a before pattern that matches at least one token of log text before the specified portion and an after pattern that matches at least one token of log text after the specified portion. In an example, inferring the second regular expression for the context may include constructing a second Grok expression from character strings of the context for the extracted field and generating the second regular expression for the context from the second Grok expression using a Grok library.

In an example, inferring the second regular expression for the context may include determining a Grok type of the specified portion of the first log message and replacing log text of the specified portion with a predetermined regular expression using a Grok library in response to determining that the Grok type is a variable Grok type for which a value of the specified portion continues to change. In another example, inferring the second regular expression for the context may include determining the Grok type of the context for the extracted field and replacing log text of the context with a predetermined regular expression using a Grok library in response to determining that the Grok type is a variable Grok type for which a value of the context continues to change.

At 210, a definition of the extracted field having the first regular expression and the second regular expression may be generated. In an example, a name of the extracted field may be generated based on a combination of parameters in the first log message. Further, the definition of the extracted field having the name of the extracted field, the first regular expression, and the second regular expression may be generated. In yet another example, an option may be provided on the graphical user interface seeking a user input to name the extracted field. Further, the definition of the extracted field having the user entered name, the first regular expression, and the second regular expression may be generated.

In yet another example, a name for the extracted field may be generated and recommended based on a combination of parameters in the first log message. Further, an option may be provided on the graphical user interface seeking a user input to modify the recommended name for the extracted field. In this example, the definition of the extracted field having the modified name, the first regular expression, and the second regular expression may be generated.

Further, method 200 includes determining the Grok type of the specified portion of the first log message. Furthermore, method 200 includes inferring a type of the specified portion based on the Grok type. Furthermore, method 300 includes generating the definition of the extracted field having the type of the specified portion, the first regular expression, and the second regular expression.

In an example, a first portion of log text of the first log message which matches the first regular expression may be annotated. Further, a second portion of log text of the first log message which matches the context may be annotated. In an example, annotating of the first and second portions of the log message may include highlighting the first portion of the log text using a first color and highlighting the second portion of the log text using a second color. The first color may have different color or intensity than the second color.

At 212, the plurality of log messages may be filtered based on the definition of the extracted field. In an example, method 200 may include annotating portions of the log text of the filtered log messages in the graphical user interface, such that for each of the filtered log messages having an instance of the extracted field that satisfies the generated definition. For example, a first portion of the filtered log message may be annotated to indicate a match with the first regular expression of the extracted field. Further, a second portion of the filtered log message may be annotated, where the second portion matches with the second regular expression of the extracted field.

Thus, examples described herein may provide a one click extracted field feature which may facilitate users to create extracted fields with just one click by dynamically extracting data from the log messages and use the extracted fields in querying log messages based on the contents inside the log messages. Further, the extracted fields may be useful in understanding the distribution of various values of the extracted fields taken out for various log messages.

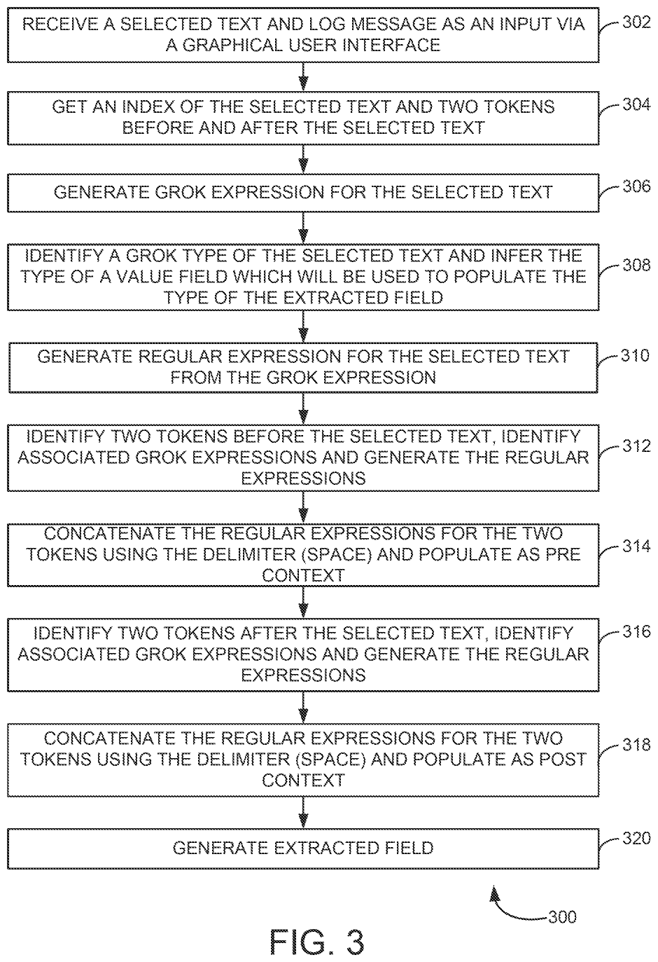

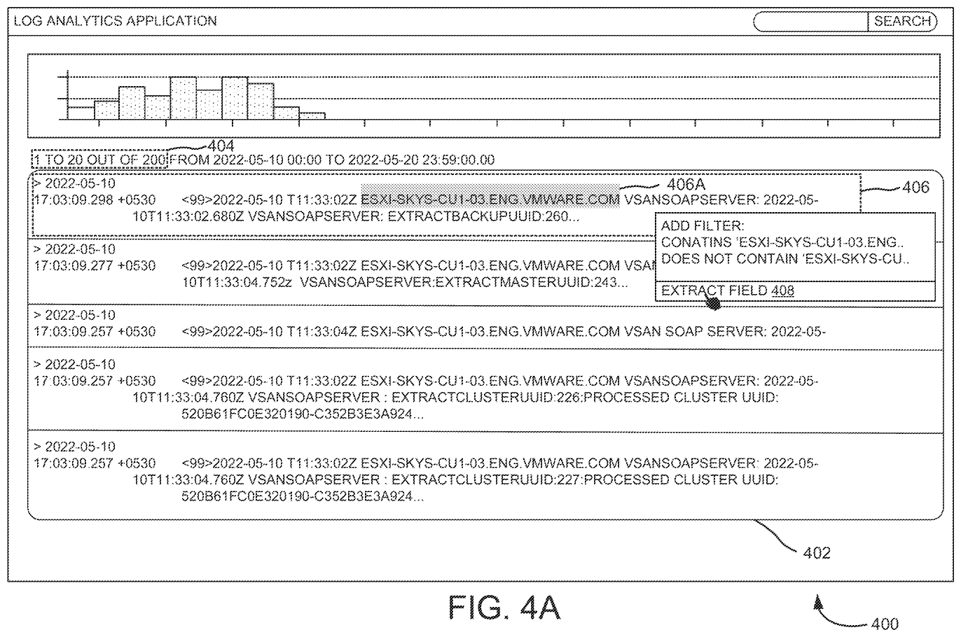

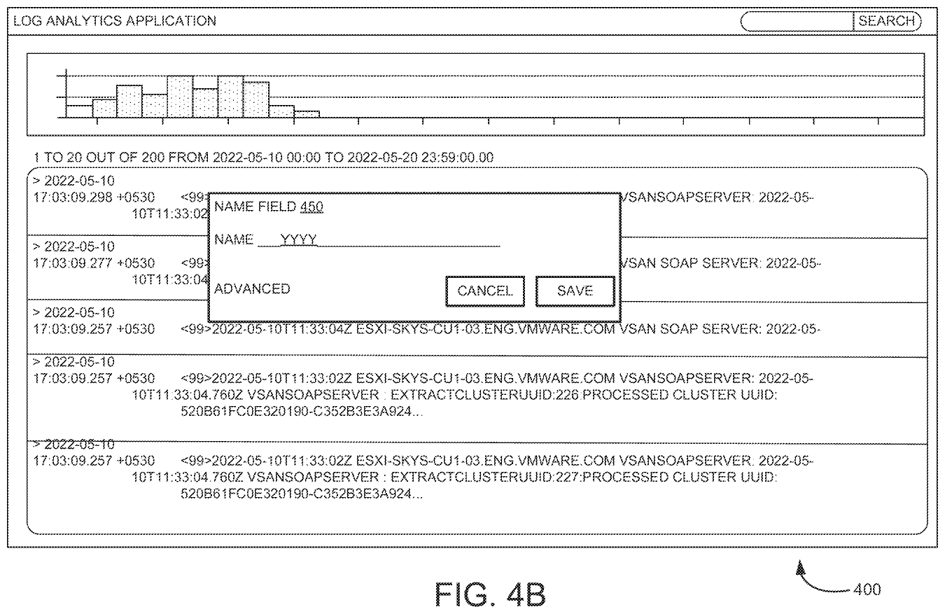

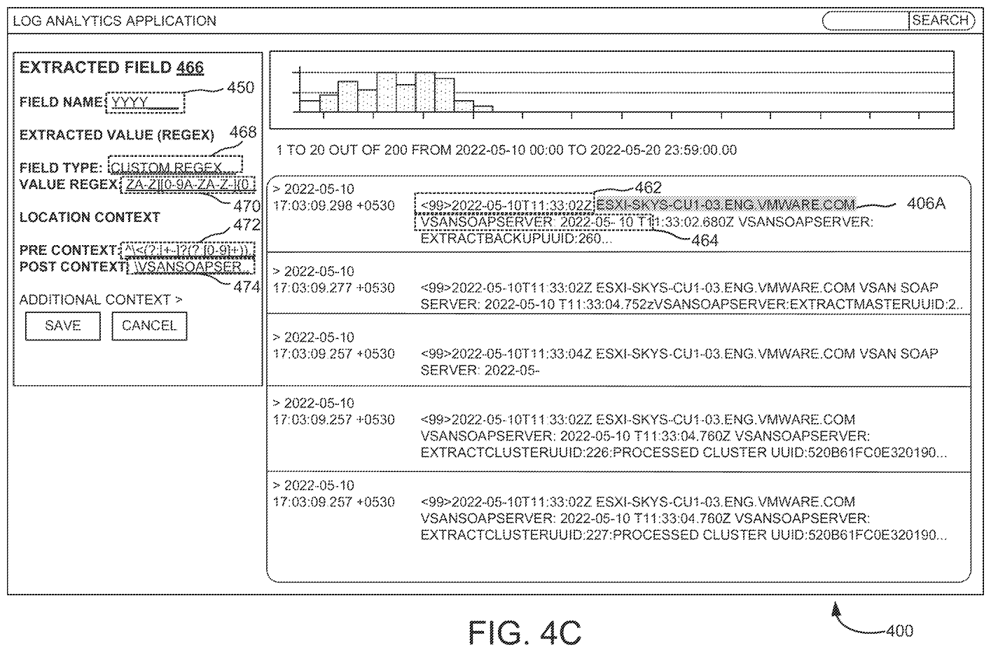

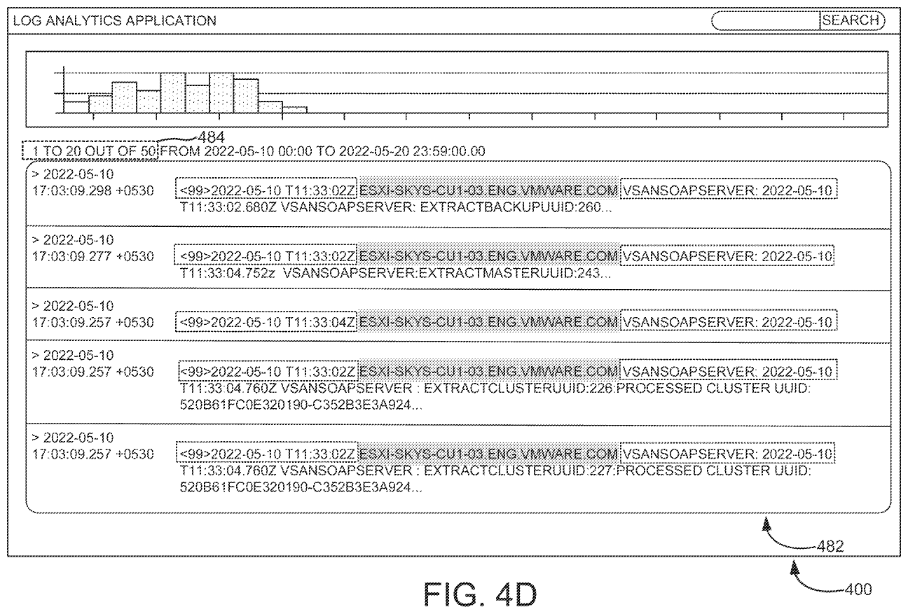

FIG. 3 is a flow diagram illustrating an example computer-implemented method 300 for generating extracted fields to filter log messages in a computing environment. At 302, a log message and a user-selected text in the log message may be received as an input via a graphical user interface. For example, a list of log messages may be displayed on the graphical user interface. From the list of log messages, a user may select a log message and decides to create an extracted field for a portion (e.g., a selected text such as a word) in the whole text of the log message. FIG. 4A shows an example graphical user interface 400 depicting a list of log messages (e.g., 402). For example, graphical user interface 400 displays 1 to 20 out of 200 log messages (e.g., as shown in 404). In this example, a user may select a portion 406A of a log message 406. Upon selecting potion 406A, an option 408 to select “extract field” may be displayed. Further, upon receiving a selection of option 408 to extract field, selected portion 406A and corresponding log message 406 is considered as input to extract the fields.

In an example, upon receiving the selection of portion 406A, an option 450 to name the extracted field may be displayed on graphical user interface 400 as shown in FIG. 4B. In this example, the user can provide the name of the extracted field as shown in FIG. 4B. In other examples, the name of the extracted field may be dynamically generated based on a combination of parameters (e.g., by concatenating event type, field number, a random number, and the like) in the log message associated with selected portion 406A.

Referring back to FIG. 3, at 304, an index of selected text 406A (i.e., a value) and two tokens before and after the value may be obtained. FIG. 4C shows example graphical user interface 400 of FIG. 4A depicting selected portion of text 406A (i.e., a value) and two tokens before selected portion of text 406A (e.g., a pre context 462) and two tokens after selected portion of text 406A (e.g., a post context 464). For example, the selected portion of text 406A on which extracted field 466 may be generated is referred to as “value”. Further, pre context 462 may be the text which is on the left side of the value (i.e., selected text 406A). In some examples, a length of pre context 462 may include a maximum of two tokens to the left starting from selected text 406A. Similarly, post context 464 may be identified, i.e., two words ahead of selected text 406A.

Referring back to FIG. 3, at 306, a grok expression may be generated for the selected text. At 308, a Grok type of the selected text may be identified, and a type of a value field may be inferred which may be used to populate the type of the extracted field. In the example shown in FIG. 4C, graphical user interface 400 depicts an example type of the value field 468. At 310, a regular expression may be generated for the selected text from the Grok expression using a Grok library. In the example shown in FIG. 4C, graphical user interface 400 depicts an example regular expression 470 generated for selected text 406A using the Grok pattern. At 312, the two tokens before the selected text may be identified, associated grok expressions may be identified, and the regular expressions may be generated for the two tokens using the Grok library. At 314, the regular expressions for the two tokens before the selected text may be concatenated using the delimiter (e.g., space) and populated as the pre context. In the example shown in FIG. 4C, graphical user interface 400 depicts an example regular expression 472 generated for pre context 462 using the Grok pattern.

At 316, the two tokens after the selected text may be identified, associated grok expressions may be identified, and the regular expressions may be generated for the two tokens using the Grok library. At 318, the regular expressions may be concatenated for the two tokens after the selected text using the delimiter (e.g., space) and populated as the post context. In the example shown in FIG. 4C, graphical user interface 400 depicts an example regular expression 474 generated for post context 464 using the Grok pattern.

At 320, the extracted field may be generated using the field name 450, type of the value field 468, regular expression 470 for selected text 406A, regular expression 472 generated for pre context 462, and regular expression 474 for post context 464. Thus, the log messages which fall with the pattern of pre context 462 and post context 464 are the result set which the user is interested in. FIG. 4D shows example graphical user interface 400 depicting a list of filtered log messages (e.g., 482). For example, the graphical user interface in FIG. 4D displays 1 to 20 out of 50 log messages (e.g., 484). In this example, the list of log messages (e.g., 402 of FIG. 4A) are filtered based on the extracted field (e.g., 466 of FIG. 4C) and the list of filtered log messages (e.g., 482) may be displayed on the graphical user interface as shown in FIG. 4D. Further, portions of the log text of filtered log messages 482 may be annotated (e.g., with different colors, different fonts, and the like) in graphical user interface 400.

Consider an example in which extracted field attributes of a given log message are as shown below:
Current value (selected text)=is
Pre context=(This]
Post context=7aa6e96a-402c-4454-8c9c-879dcd981805) test

Consider that an extracted field is generated using the above field attributes. Using the above attributes, all the log messages which are matching the current value and having corresponding pre context and post context may be filtered out and output the filtered messages. If the above attributes can be generified, then all the corresponding log messages can be extracted irrespective of variable fields in the text. To generify, the regular expressions can be created for the attributes using the Grok pattern as follows.

In this example, a Grok engine may help in first obtaining the grok expression and then convert the Grok expression to a regular expression (regex). For current value attribute, the Grok engine may generate a Grok expression and then convert the grok expression to a first regex for the current value. The first regex can be used to filter out the log messages.

Further, Grok engine may identify the grok expression for the pre/post context. Further, a regex for pre/post context may be obtained by converting the grok expression for the pre/post context. The Grok expression for the pre context and post context may be as shown below:
%{WORD-word} for pre-context
%{UUID:uuid}\s %{WORD:word} for post-context

Furthermore, upon obtaining the grok expression, the grok types and the actual word may be mapped in the pre context and post context as follows.

TABLE

| Grok type | List of matching words in the text |
|---|---|
| Word | [“This”, “test”] |
| Uuid | [“7aa6e96a-402c-4454-8c9c-879dcd981805”] |

For example, in the above table, UUID is a variable grok type for which the value keeps on changing. This grok expression can be categorized into a variable grok type. And for such variable grok types, the regex is precalculated and fed into the system/cache memory. At the final step of the algorithm, if a grok type is of non-variable type then no modification is done for the pre/post context. For variable grok types, the pre/post context is replaced with the regex taken from the cache memory. The final pre/post context and the current value after the execution are shown below.
Current value=“\b\w+\b”
Pre text=“This”
Post text=“[A-Fa-f0-9]{8}-(?:[A-Fa-f0-9]{4}-){3}[A-Fa-f0-9]{12}\stest”

With the examples described herein, the regular expressions for pre context, post context, and value can be inferred automatically. Further, the name of the extracted field may be generated by combining event type identifier, field number inside the grok expression, and a random number which reduces the changes of the conflict. With this, the user has to just click once to get the field created and the extracted fields may be populated at runtime. For example, the value regular expression may be inferred from the given log using Grok patterns. Further, the pre context and post context may be inferred automatically from the logs. Furthermore, the corresponding regular expressions may be generated at runtime and prefill it for the user. Upon generating regular expressions, an accurate regular expression may be created, which may be specific to the context to avoid the generic regular expression.

Thus, examples described herein may present methods and systems to create extracted fields in just one click by computing the regular expressions using Grok patterns. With this approach, the user's burden of writing the regular expressions by themselves while creating this fields may be reduced. Further, examples described herein may accelerate the usage of the fields by the users and provide a capability for the users to create these fields in bulk. Also, examples described herein effectively improve the accuracy of extracted fields, reduce the user's pain, and improve the performance of the system by creating specific regular expression which uses less central processing unit (CPU) cycles in contrary to existing methods, where the user creates generic expressions consuming multiple CPU cycles to process the same log messages.

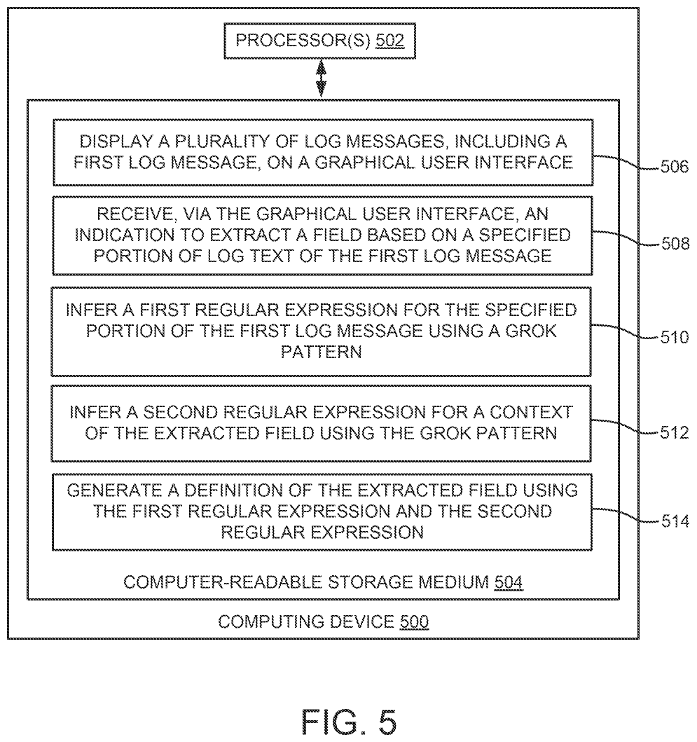

FIG. 5 is a block diagram of an example computing device 500 including non-transitory computer-readable storage medium 504 storing instructions to generate a definition of an extracted field. Computing device 500 may include a processor 502 and computer-readable storage medium 504 communicatively coupled through a system bus. Processor 502 may be any type of central processing unit (CPU), microprocessor, or processing logic that interprets and executes computer-readable instructions stored in computer-readable storage medium 504. Computer-readable storage medium 504 may be a random-access memory (RAM) or another type of dynamic storage device that may store information and computer-readable instructions that may be executed by processor 502. For example, computer-readable storage medium 504 may be synchronous DRAM (SDRAM), double data rate (DDR), Rambus® DRAM (RDRAM), Rambus® RAM, etc., or storage memory media such as a floppy disk, a hard disk, a CD-ROM, a DVD, a pen drive, and the like. In an example, computer-readable storage medium 504 may be a non-transitory computer-readable medium. In an example, computer-readable storage medium 504 may be remote but accessible to computing device 500.

Computer-readable storage medium 504 may store instructions 506, 508, 510, 512, and 514. Instructions 506 may be executed by processor 502 to display a plurality of log messages, including a first log message, on a graphical user interface. Further, instructions 508 may be executed by processor 502 to receive, via the graphical user interface, an indication to extract a field based on a specified portion of log text of the first log message.

Instructions 510 may be executed by processor 502 to infer a first regular expression for the specified portion of the first log message using a Grok pattern. In an example, the first regular expression associated with the definition of the extracted field may be a value type determined based on a match from the Grok pattern. Instructions 512 may be executed by processor 502 to infer a second regular expression for a context of the extracted field using the Grok pattern. The context may be determined based on the specified portion. In an example, the second regular expression for the context may include a before pattern that matches at least one token of log text before the specified portion and an after pattern that matches at least one token of log text after the specified portion.

Instructions 514 may be executed by processor 502 to generate a definition of the extracted field using the first regular expression and the second regular expression. In an example, instructions 514 to generate the definition of the extracted field include instructions to populate a template of the extracted field with the first regular expression and the second regular expression. For example, instructions 514 to generate the definition of the extracted field having the second regular expression may include instructions to determine a Grok type of the context for the extracted field and replace log text of the context with a predetermined regular expression using a Grok library in response to determine that the Grok type of the log text is a variable Grok type for which a value of the context continues to change.

Further, computer-readable storage medium 504 may store instructions to filter the plurality of log messages based on the extracted field and annotate portions of the log text of the filtered log messages in the graphical user interface, such that for each of the filtered log messages having an instance of the extracted field that satisfies the generated definition. For example, a first portion of the filtered log message may be annotated to indicate a match with the first regular expression of the extracted field. Further, a second portion of the filtered log message may be annotated, which matches with the second regular expression of the extracted field.

In another example, computer-readable storage medium 504 may store instructions annotate a first portion of log text of the first log message which matches the first regular expression of the extracted field and annotate a second portion of log text of the first log message which matches the second regular expression of the extracted field.

The above-described examples are for the purpose of illustration. Although the above examples have been described in conjunction with example implementations thereof, numerous modifications may be possible without materially departing from the teachings of the subject matter described herein. Other substitutions, modifications, and changes may be made without departing from the spirit of the subject matter. Also, the features disclosed in this specification (including any accompanying claims, abstract, and drawings), and any method or process so disclosed, may be combined in any combination, except combinations where some of such features are mutually exclusive.

The terms “include,” “have,” and variations thereof, as used herein, have the same meaning as the term “comprise” or appropriate variation thereof. Furthermore, the term “based on”, as used herein, means “based at least in part on.” Thus, a feature that is described as based on some stimulus can be based on the stimulus or a combination of stimuli including the stimulus. In addition, the terms “first” and “second” are used to identify individual elements and may not meant to designate an order or number of those elements.

The present description has been shown and described with reference to the foregoing examples. It is understood, however, that other forms, details, and examples can be made without departing from the spirit and scope of the present subject matter that is defined in the following claims.

What is claimed is:

1. A method for displaying a graphical user interface for analyzing a plurality of log messages for a computing environment, the method comprising:
displaying the plurality of log messages, including a first log message;
receiving an indication to extract a field based on a specified portion of log text of the first log message;
inferring a first regular expression for the specified portion of the first log message using a Grok pattern;
inferring a second regular expression for a context of the extracted field using the Grok pattern, wherein the context is determined based on the specified portion;
generating a definition of the extracted field having the first regular expression and the second regular expression; and
filtering the plurality of log messages based on the definition of the extracted field.

2. The method of claim 1, wherein inferring the first regular expression for the specified portion comprises:
constructing a first Grok expression from character strings of the specified portion; and
generating the first regular expression for the specified portion from the first Grok expression using a Grok library.

3. The method of claim 1, wherein inferring the second regular expression for the context comprises:
constructing a second Grok expression from character strings of the context for the extracted field; and
generating the second regular expression for the context from the second Grok expression using a Grok library.

4. The method of claim 1, further comprising:
determining a Grok type of the specified portion of the first log message;
inferring a type of the specified portion based on the Grok type; and
generating the definition of the extracted field having the type of the specified portion, the first regular expression, and the second regular expression.

5. The method of claim 1, further comprising:
generating a name of the extracted field based on a combination of parameters in the first log message; and
generating the definition of the extracted field having the name of the extracted field, the first regular expression, and the second regular expression.

6. The method of claim 1, further comprising:
recommending a name for the extracted field based on a combination of parameters in the first log message.

7. The method of claim 6, further comprising:
providing an option on the graphical user interface seeking a user input to modify the recommended name for the extracted field.

8. The method of claim 1, further comprising:
providing an option on the graphical user interface seeking a user input to name the extracted field.

9. The method of claim 1, wherein the first regular expression associated with the definition of the extracted field is a value type determined for the specified portion based on a match from the Grok pattern.

10. The method of claim 1, wherein the second regular expression for the context comprises a before pattern that matches at least one token of log text before the specified portion and an after pattern that matches at least one token of log text after the specified portion.

11. The method of claim 1, wherein receiving the indication to extract the field based on the specified portion further comprises:
receiving a text selection, from a user via the graphical user interface, which indicates the specified portion of log text.

12. The method of claim 1, further comprising:
annotating a first portion of log text of the first log message which matches the first regular expression; and
annotating a second portion of log text of the first log message which matches the context.

13. The method of claim 12, wherein annotating of the first and second portions of the log message comprises:
highlighting the first portion of the log text using a first color; and
highlighting the second portion of the log text using a second color, wherein the first color has different color or intensity than the second color.

14. The method of claim 1, further comprising:
annotating portions of the log text of the filtered log messages in the graphical user interface, such that for each of the filtered log messages having an instance of the extracted field that satisfies the generated definition:
annotating a first portion of the filtered log message to indicate a match with the first regular expression of the extracted field; and
annotating a second portion of the filtered log message, the second portion which matches with the second regular expression of the extracted field.

15. The method of claim 1, wherein inferring the second regular expression for the context comprises:
determining a Grok type of the specified portion of the first log message; and
replacing log text of the specified portion with a predetermined regular expression using a Grok library in response to determining that the Grok type is a variable Grok type for which a value of the specified portion continues to change.

16. The method of claim 1, wherein inferring the second regular expression for the context comprises:
determining a Grok type of the context for the extracted field; and
replacing log text of the context with a predetermined regular expression using a Grok library in response to determining that the Grok type is a variable Grok type for which a value of the context continues to change.

17. A computer system for displaying a graphical user interface for analyzing a plurality of log messages for a computing environment, the computer system comprising:
a processor; and
a memory coupled to the processor, wherein the memory comprises a field extraction unit to:
display the plurality of log messages, including a first log message comprised of log text;
receive an indication to extract a field based on a specified portion of log text of the first log message;
generate a definition of the extracted field having a first regular expression that matches the specified portion and a second regular expression for a context of the extracted field that is determined based on the specified portion, wherein the first regular expression and the second regular expression are determined using a Grok pattern; and
filter the plurality of log messages based on the definition of the extracted field.

18. The computer system of claim 17, further comprising:
a storage device storing the plurality of log messages including the first log message comprised of the log text.

19. The computer system of claim 17, wherein the field extraction unit is to:
construct a first Grok expression and a second Grok expression from character strings of the specified portion and the context, respectively;
generate the first regular expression for the specified portion from the first Grok expression using a Grok library;
generate the second regular expression for the context from the second Grok expression using the Grok library; and
generate the definition of the extracted using the first regular expression and the second regular expression.

20. The computer system of claim 17, wherein the second regular expression for the context comprises a before pattern that matches at least two tokens of log text before the specified portion and an after pattern that matches at least two tokens of log text after the specified portion.

21. The computer system of claim 20, wherein the field extraction unit is to:
concatenate first regular expressions corresponding to the at least two tokens before the specified portion using a delimiter and populate the concatenated first regular expressions as a pre-context for the extracted field; and
concatenate second regular expressions corresponding to the at least two tokens after the specified portion using a delimiter and populate the concatenated second regular expressions as a post-context for the extracted field.

22. A non-transitory computer-readable storage medium storing instructions that, when executed by a processor of a computing device, cause the processor to:
display a plurality of log messages, including a first log message, on a graphical user interface;
receive, via the graphical user interface, an indication to extract a field based on a specified portion of log text of the first log message;
infer a first regular expression for the specified portion of the first log message using a Grok pattern;
infer a second regular expression for a context of the extracted field using the Grok pattern, wherein the context is determined based on the specified portion; and
generate a definition of the extracted field using the first regular expression and the second regular expression.

23. The non-transitory computer-readable storage medium of claim 22, further comprising instructions to:
annotate a first portion of log text of the first log message which matches the first regular expression of the extracted field; and
annotate a second portion of log text of the first log message which matches the second regular expression of the extracted field.

24. The non-transitory computer-readable storage medium of claim 22, further comprising instructions to:
filter the plurality of log messages based on the extracted field; and
annotate portions of the log text of the filtered log messages in the graphical user interface, such that for each of the filtered log messages having an instance of the extracted field that satisfies the generated definition:
annotate a first portion of the filtered log message to indicate a match with the first regular expression of the extracted field; and
annotate a second portion of the filtered log message, the second portion which matches with the second regular expression of the extracted field.

25. The non-transitory computer-readable storage medium of claim 22, wherein the first regular expression associated with the definition of the extracted field is a value type determined based on a match from the Grok pattern.

26. The non-transitory computer-readable storage medium of claim 22, wherein the second regular expression for the context comprises a before pattern that matches at least one token of log text before the specified portion and an after pattern that matches at least one token of log text after the specified portion.

27. The non-transitory computer-readable storage medium of claim 22, wherein instructions to generate the definition of the extracted field having the first regular expression and the second regular expression comprises instructions to:
determine a Grok type of the context for the extracted field; and
replace log text of the context with a predetermined regular expression using a Grok library in response to determine that the Grok type of the log text is a variable Grok type for which a value of the context continues to change.

28. The non-transitory computer-readable storage medium of claim 22, wherein instructions to generate the definition of the extracted field comprise instructions to:
populate a template of the extracted field with the first regular expression and the second regular expression.
